(19) United States
(12) Patent Application Publication
(10) Pub. No.: US 2025/0389901 A1
(43) Pub. Date: Dec. 25, 2025

(54) FERRULE AND OPTICAL CONNECTION STRUCTURE

(71) Applicant: Fujikura Ltd., Tokyo (JP)

(72) Inventors: Masayuki Hirose, Sakura-shi (JP); Akihiro Nakama, Sakura-shi (JP)

(73) Assignee: Fujikura Ltd., Tokyo (JP)

(21) Appl. No.: 18/834,452

(22) PCT Filed: Nov. 2, 2022
(86) PCT No.: PCT/JP2022/040960

§ 371 Date: Jul. 30, 2024

(30) Foreign Application Priority Data
Mar. 9, 2022 (JP) 2022-036444

(51) Int. Cl. G02B 6/38; G02B 6/42

(52) U.S. Cl. CPC G02B 6/3839; G02B 6/3853; G02B 6/3881; G02B 6/3893; G02B 6/3897; G02B 6/423

(57) ABSTRACT

An object of the present invention is to provide a ferrule and an optical connection structure capable of stabilizing optical connection quality when performing positioning without using pins. A ferrule (50) according to the present invention has a fiber hole (51) into which an optical fiber (F) is to be inserted, a light-emitting surface from which light that has passed through the optical fiber (F) is to be emitted, and a longitudinal reference surface (50a) that determines a position of the ferrule (50) in a longitudinal direction with respect to a receptacle (30). The longitudinal reference surface (50a) is positioned between a center line (O) passing through a center position of the ferrule (50) in the longitudinal direction and the light-emitting surface.

### TECHNICAL FIELD

The present invention relates to a ferrule and an optical connection structure.

Priority is claimed on Japanese Patent Application No. 2022-036444, filed Mar. 9, 2022, the content of which is incorporated herein by reference.

### BACKGROUND ART

Patent Document 1 discloses an optical connection structure for connecting a photonic element and an optical fiber. In Patent Document 1, the positioning of the optical connector in the direction perpendicular to a longitudinal direction of the optical fiber is performed by a positioning pin. In addition, the positioning of the optical connector in the longitudinal direction is performed by abutting the ferrule of the optical connector against an adapter.

### CITATION LIST

### Patent Document

[Patent Document 1]: United States Patent Application, Publication No. 2021/0055489

### SUMMARY OF INVENTION

### Technical Problem

In Patent Document 1, the external dimension of the ferrule is larger by the thickness of the pin. In a case where positioning is performed using the outer shape of the ferrule without using the pin, it is possible to reduce the size of the ferrule.

Here, according to the considerations made by the present inventors, it was found that, in a case where the ferrule is positioned without using the pin, the disposition of the reference plane serving as a reference for the ferrule position in the longitudinal direction affects the optical connection quality using the optical connector.

The present invention has been made in consideration of such circumstances, and an object thereof is to provide a ferrule and an optical connection structure capable of stabilizing optical connection quality when performing positioning without using pins.

### Solution to Problem

In order to achieve the above object, according to one aspect of the present invention, there is provided a ferrule that is connected to a receptacle fixed to an optical integrated circuit. The ferrule includes a fiber hole into which an optical fiber is to be inserted; a light-emitting surface from which light that has passed through the optical fiber is to be emitted; and a longitudinal reference surface configured to determine a position of the ferrule with respect to the receptacle in a longitudinal direction of the optical fiber. The longitudinal reference surface is positioned between a center line passing through a center position of the ferrule in the longitudinal direction and the light-emitting surface.

In addition, an optical connection structure according to one aspect of the present invention includes the ferrule; the receptacle; and a holding member configured to hold a state in which the ferrule and the receptacle are positioned. The ferrule includes a pressure-receiving surface configured to receive a biasing force in a direction intersecting with the longitudinal direction, and a sliding surface that is disposed away from the pressure-receiving surface and slides on the receptacle. The holding member has a biasing portion that applies the biasing force to the pressure-receiving surface. The receptacle has a receptacle-side sliding surface that slides on the sliding surface. A recessed portion into which a part of the ferrule is allowed to enter is formed in the receptacle-side sliding surface. In a case where a direction in which light is emitted from the light-emitting surface is defined as a front side, an inclined surface that is inclined to be closer to the receptacle-side sliding surface toward the front side is formed on an inner side of the recessed portion.

### Advantageous Effects of Invention

According to the above aspects of the present invention, it is possible to provide the ferrule and the optical connection structure capable of stabilizing optical connection quality when performing positioning without using pins.

### BRIEF DESCRIPTION OF DRAWINGS

FIG. 1 is a diagram showing an optical connection structure according to the present embodiment.

FIG. 2 is a perspective view showing a vicinity of one optical connection unit of FIG. 1.

FIG. 3A is an exploded perspective view of FIG. 2.

FIG. 3B is a perspective view of the vicinity of a receptacle of FIG. 3A as viewed from below.

FIG. 3C is a perspective view of an optical connector of FIG. 3A as viewed from the front.

FIG. 4 is a schematic diagram showing the transfer of light between an optical fiber and an optical integrated circuit in the present embodiment.

FIG. 5 is a sectional view taken along line V-V of FIG. 2.

FIG. 6 is a sectional view taken along line VI-VI of FIG. 2.

FIG. 7A is a diagram showing a method of connecting the ferrule and the receptacle in the present embodiment.

FIG. 7B is a diagram showing a state subsequent to the state shown in FIG. 7A.

FIG. 7C is a diagram showing a state subsequent to the state shown in FIG. 7B.

### DESCRIPTION OF EMBODIMENTS

Hereinafter, a ferrule and an optical connection structure according to the present embodiment will be described with reference to the drawings.

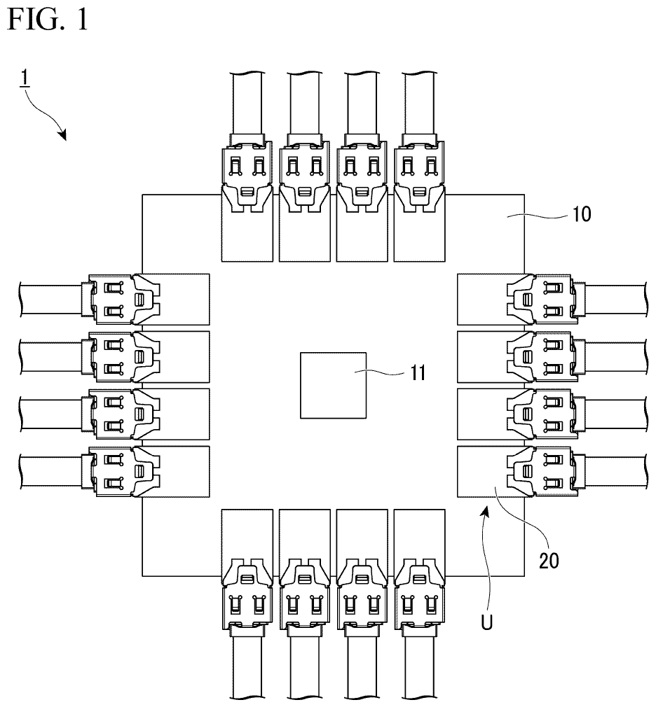

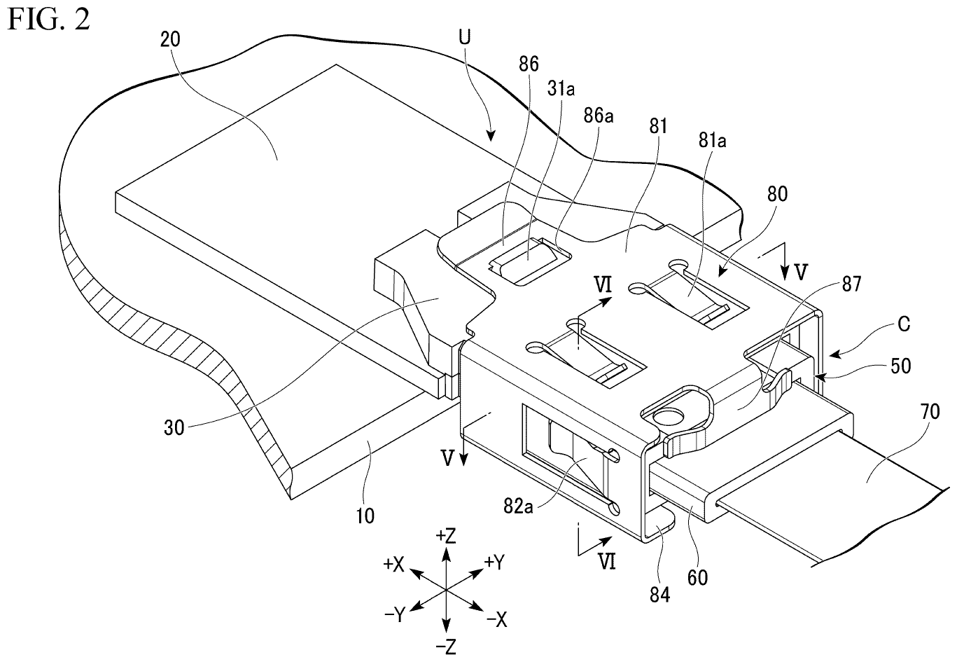

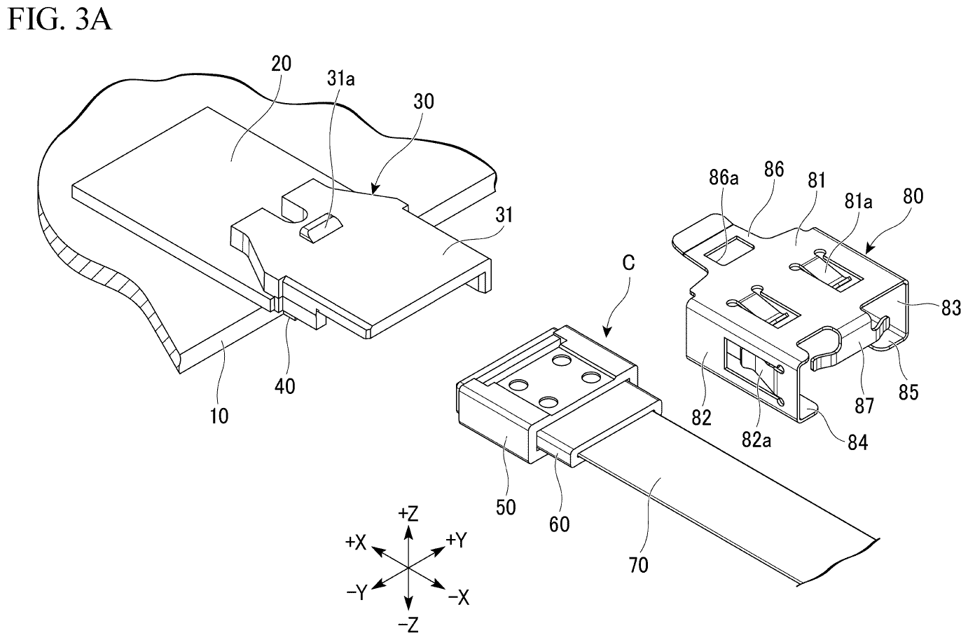

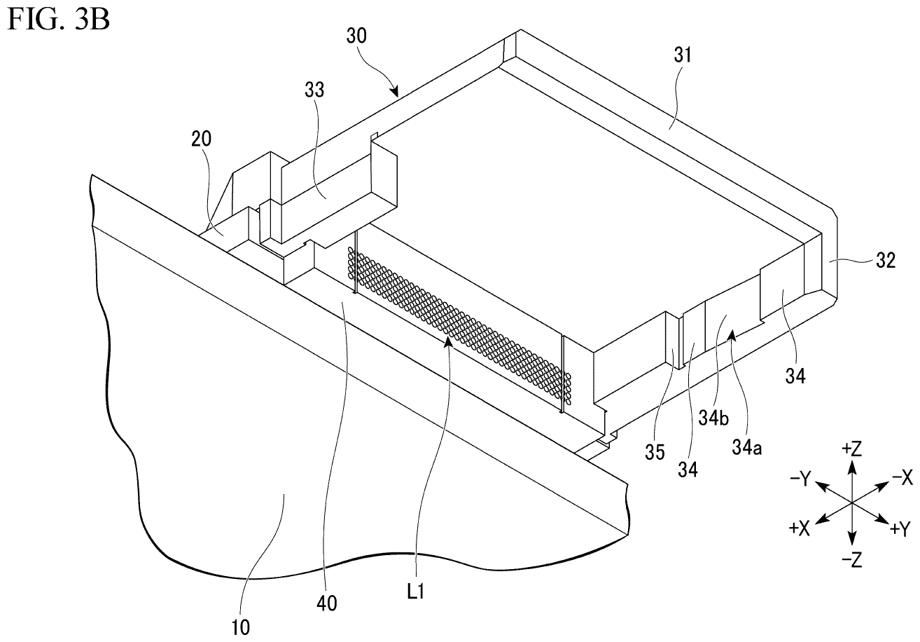

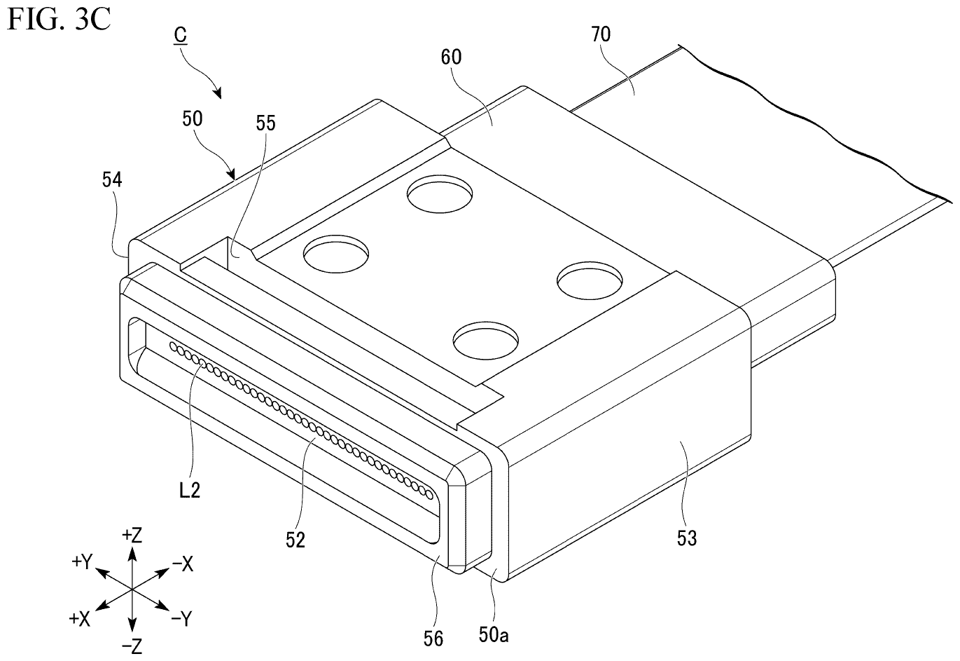

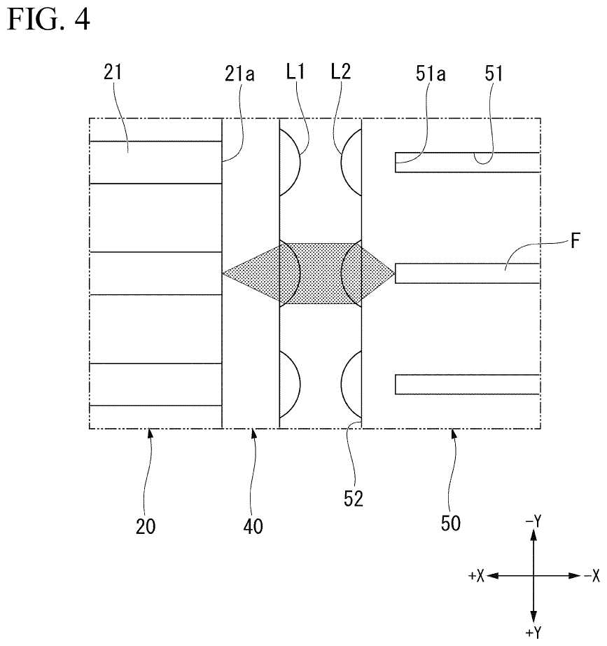

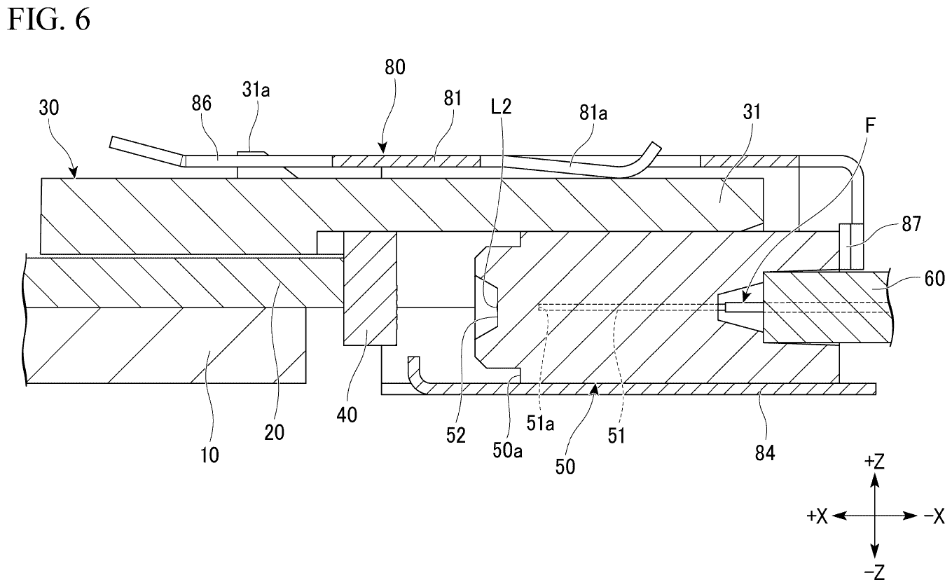

As shown in FIG. 1, an optical connection structure 1 includes a substrate 10 and a plurality of optical connection units U. As shown in FIGS. 2, 3A, and 3B, each optical connection unit U includes an optical integrated circuit 20, a receptacle 30, a microlens array 40, an optical connector C, and a holding member 80. The optical connector C includes a ferrule 50, a boot 60, and a tape core 70. A plurality of fiber holes 51 (see FIGS. 4 and 6) into which a plurality of optical fibers F can be inserted are formed in the ferrule 50. The plurality of fiber holes 51 are arranged in one direction perpendicular to the longitudinal direction of each fiber hole 51.

### (Definition of Direction)

Here, in the present embodiment, an XYZ Cartesian coordinate system is set, and a positional relationship of each configuration will be described. The X-axis direction is the longitudinal direction of each fiber hole 51. The Y-axis direction is a direction in which the plurality of fiber holes 51 are arranged. The Z-axis direction is a direction perpendicular to both the X-axis and the Y-axis. In the present specification, the X-axis direction may be referred to as a longitudinal direction X, the Y-axis direction may be referred to as a first direction Y, and the Z-axis direction may be referred to as a second direction Z. A direction from the ferrule 50 to the optical integrated circuit 20 in the longitudinal direction X is referred to as an +X side or a front side. A direction opposite to the +X side is referred to as a −X side or a rear side. One direction in the first direction Y is referred to as a +Y side or a left side. A direction opposite to the +Y side is referred to as a −Y side or a right side. A direction from the substrate 10 to the optical integrated circuit 20 in the second direction Z is referred to as a +Z side or an upper side. A direction opposite to the +Z side is referred to as a −Z side or a lower side.

In the present embodiment, the plurality of optical fibers F are collectively coated or intermittently fixed to each other to configure the tape core 70. In addition, the plurality of optical fibers F may not configure the tape core 70, and each optical fiber F may be individually coated. The boot 60 has a tubular shape extending in the longitudinal direction X, and the tape core 70 is inserted into the boot 60. The boot 60 is formed of a material having elasticity and extends toward the −X side from the ferrule 50. The boot 60 has a role of relieving bending and stress applied to the optical fiber F.

As shown in FIG. 1, an electronic component 11 is mounted on an upper surface of the substrate 10. In addition, a circuit pattern (not shown) electrically connected to the electronic component 11 is formed on the substrate 10. The electronic component 11 may be, for example, a switch circuit. The plurality of optical connection units U are disposed to surround the electronic component 11.

The optical integrated circuit 20 is mounted on the upper surface of the substrate 10. The optical integrated circuit 20 is formed in a rectangular parallelepiped shape. The optical integrated circuit 20 has a light-receiving element (not shown) that converts an optical signal into an electrical signal and a light-emitting element (not shown) that converts the electrical signal into an optical signal. As the light-receiving element, for example, a photodetector such as a photodiode can be used. As the light-emitting element, for example, a semiconductor laser or a light-emitting diode can be used.

In FIG. 3B, the optical integrated circuit 20, the microlens array 40, and the receptacle 30 are fixed to each other by an adhesive. For example, a front surface (end surface on the +X side) of the microlens array 40 may be adhesively fixed to a rear surface (end surface on the −X side) of the optical integrated circuit 20. In this case, since the optical signal passes through the layer of the adhesive, it is preferable that the adhesive is a material that transmits light. However, the method of fixing the optical integrated circuit 20, the receptacle 30, and the microlens array 40 is not limited to the above and may be appropriately changed.

As shown in FIG. 4, the optical integrated circuit 20 has a plurality of waveguides 21. In addition, the waveguides 21 are not shown in the drawings other than FIG. 4. Each of the waveguides 21 is optically connected to the above-described light-receiving element and light-emitting element. In the present embodiment, each waveguide 21 extends in the longitudinal direction X. Each of the waveguides 21 is formed of, for example, silicon. The refractive index of the waveguide 21 is higher than the refractive index of a portion of the optical integrated circuit 20 other than the waveguide 21. Accordingly, the optical signal is confined inside the waveguide 21 and propagates in the longitudinal direction X. The waveguide 21 may be provided on a surface (upper surface) of the optical integrated circuit 20 or may be provided inside the optical integrated circuit 20. An incidence and exit portion 21a is provided at a rear end (end portion on the −X side) of each waveguide 21. The incidence and exit portion 21a is a portion of the waveguide 21 and receives and emits the optical signal.

As shown in FIG. 4, an abutting surface 51a against which an end portion of the optical fiber F on the +X side is butted is formed on an inner side of the fiber hole 51 of the ferrule 50. The abutting surface 51a faces the −X side. In a case where the optical connector C is assembled, each of the plurality of optical fibers F is inserted into each of the plurality of fiber holes 51 and are butted against the abutting surface 51a of each fiber hole 51.

The ferrule 50 has a lens-forming surface 52 facing the microlens array 40 in the longitudinal direction X. A plurality of lenses L2 arranged in the first direction Y are formed on the lens-forming surface 52.

The microlens array 40 is formed of a member capable of transmitting light. The microlens array 40 may be formed of, for example, quartz glass or a silicon substrate. In the present embodiment, the shape of the microlens array 40 is a rectangular plate shape. As shown in FIG. 3B, a plurality of lenses L1 are formed in the microlens array 40.

In a case where the optical connector C is connected to the receptacle 30, as shown in FIG. 4, the ferrule 50 and the microlens array 40 face each other in the longitudinal direction X. More specifically, the plurality of lenses L2 formed on the ferrule 50 face the plurality of lenses L1 of the microlens array 40. The optical signal that has travelled in the optical fiber F to the +X side enters the ferrule 50 from the abutting surface 51a of the fiber hole 51. In addition, the optical signal is emitted to the +X side from the lens L2 of the ferrule 50. That is, the surface of the lens L2 is a light-emitting surface from which the light is emitted from the ferrule 50.

The light emitted from the ferrule 50 is incident into the microlens array 40 from the lens L1. In addition, the light that has passed through the microlens array 40 is received by the incidence and exit portion 21a of the optical integrated circuit 20 and propagates in the waveguide 21. Then, the optical signal is converted into an electrical signal by the light-receiving element provided in the optical integrated circuit 20 and is transferred to the substrate 10. On the contrary, the electrical signal transmitted from the substrate 10 to the optical integrated circuit 20 is converted into an optical signal by the light-emitting element provided in the optical integrated circuit 20. Then, the optical signal propagates in the waveguide 21 and is emitted toward the optical fiber F from the incidence and exit portion 21a. In this way, the optical connection structure 1 performs connection of light between the optical fiber F and the optical integrated circuit 20.

The optical connector C is attached to the receptacle 30 and can be detached from the receptacle 30 (details will be described below). The receptacle 30 has a role of positioning the ferrule 50 of the optical connector C with respect to the optical integrated circuit 20.

As shown in FIG. 3B, the receptacle 30 has an upper wall 31, a first side wall 32, and a second side wall 33. The upper wall 31 has a plate shape extending in the first direction Y and the longitudinal direction X. The first side wall 32 extends toward the −Z side from an end portion of the upper wall 31 on the +Y side. The second side wall 33 extends toward the −Z side from an end portion of the upper wall 31 on the −Y side.

In a case where the dimensions in the longitudinal direction X are compared, the dimension of the second side wall 33 is smaller than the dimension of the first side wall 32. The first side wall 32 and the second side wall 33 are disposed at a distance from each other in the first direction Y. In a case where the optical connector C is connected to the receptacle 30, the ferrule 50 enters between the first side wall 32 and the second side wall 33.

As shown in FIG. 3A, a protrusion 31a protruding toward the +Z side is formed on the upper wall 31. A locking portion 86 (described below) of the holding member 80 is locked to the protrusion 31a.

As shown in FIG. 3B, the first side wall 32 has a receptacle-side sliding surface 34 facing the −Y side. A recessed portion 34a recessed toward the +Y side is formed in the receptacle-side sliding surface 34. The receptacle-side sliding surface 34 is divided into two parts separated from each other in the longitudinal direction X by the recessed portions 34a.

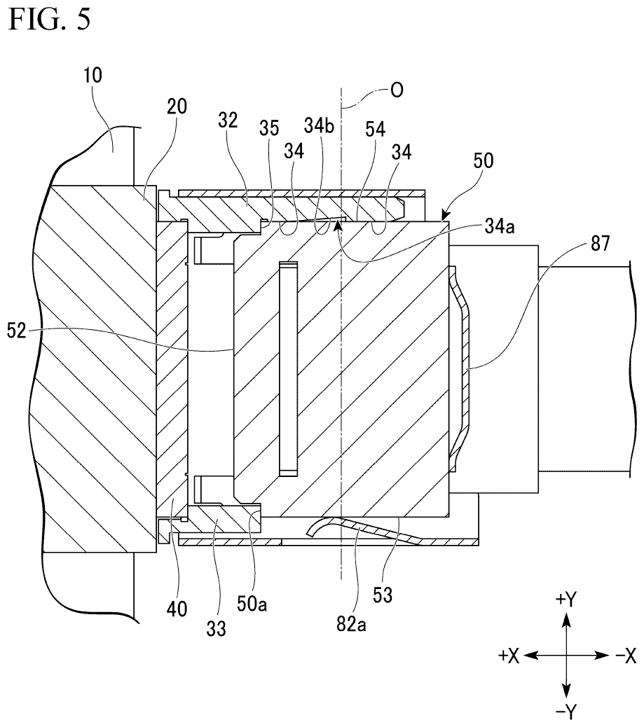

As shown in FIG. 5, an inclined surface 34b is formed on the inner side of the recessed portion 34a. The inclined surface 34b is inclined to face the −Y side as being closer to the +X side. In other words, the inclined surface 34b is inclined to be closer to the receptacle-side sliding surface 34 toward the +X side.

A positioning surface 35 facing the −X side is formed on the first side wall 32. The positioning surface 35 is positioned closer to the +X side than the receptacle-side sliding surface 34. The positioning surface 35 has a role of determining a relative position between the receptacle 30 and the ferrule 50 in the longitudinal direction X. A positioning surface positioned in the same plane as the positioning surface 35 of the first side wall 32 is also formed on the second side wall 33. The ferrule 50 is butted against the two positioning surfaces.

As shown in FIG. 3C, the ferrule 50 is formed in a substantially rectangular parallelepiped shape. The ferrule 50 is, for example, a molded product having a resin having transparency as a material. The ferrule 50 has a longitudinal reference surface 50a, the plurality of fiber holes 51 (see FIG. 4), the lens-forming surface 52, a pressure-receiving surface 53, a sliding surface 54, a filling hole 55, and a dustproof wall 56. The plurality of fiber holes 51 are arranged in the first direction Y. A plurality of lenses L2 are formed on the lens-forming surface 52 so as to protrude to the +X side. The lens-forming surface 52 is a surface that is positioned at a position closest to the +X side in the ferrule 50 except for the dustproof wall 56 and the lens L2.

The position of each lens L2 corresponds to the position of each fiber hole 51. More specifically, as viewed from the longitudinal direction X, each lens L2 is disposed at a position overlapping the corresponding fiber hole 51. The dustproof wall 56 protrudes to the +X side from the longitudinal reference surface 50a. The dustproof wall 56 has a rectangular frame shape as viewed from the longitudinal direction X and surrounds the lens-forming surface 52 and the lens L2. The dustproof wall 56 has a role of preventing dust or the like from adhering to the lens-forming surface 52 and the lens L2. However, the dustproof wall 56 may not be provided.

The filling hole 55 penetrates the ferrule 50 in the second direction Z. In a case where the optical connector C is assembled, after the optical fiber F is inserted into the fiber hole 51, an adhesive is injected from the filling hole 55. Accordingly, the optical fiber F can be fixed to the ferrule 50.

The pressure-receiving surface 53 and the sliding surface 54 are both end surfaces of the ferrule 50 in the first direction Y. In the present embodiment, the pressure-receiving surface 53 is an end surface on the −Y side, and the sliding surface 54 is an end surface on the +Y side. However, a positional relationship between the pressure-receiving surface 53 and the sliding surface 54 may be reversed. The pressure-receiving surface 53 is a part that receives a biasing force from a biasing portion 82a (described below) of the holding member 80. The sliding surface 54 is a part that slides on the receptacle 30. That is, in a case where the optical connector C is connected to the receptacle 30, the ferrule 50 slides on the sliding surface 54 with respect to the receptacle 30.

The holding member 80 has a role of holding a state where the ferrule 50 is positioned in the receptacle 30. As shown in FIG. 3A, the holding member 80 has a top plate 81, a first side plate 82, a second side plate 83, a first support plate 84, a second support plate 85, and a locking portion 86. The holding member 80 according to the present embodiment is formed by shaping a metal plate. However, the material, the shape, and the manufacturing method of the holding member 80 may be appropriately changed.

As shown in FIG. 2, in a state where the holding member 80 holds the relative position between the optical connector C and the receptacle 30, the top plate 81 is positioned on the +Z side of the receptacle 30, and the first support plate 84 and the second support plate 85 are positioned on the −Z side of the receptacle 30. In addition, the receptacle 30 and the ferrule 50 are disposed between the first side plate 82 and the second side plate 83.

As shown in FIG. 3A, the top plate 81 extends in the first direction Y and the longitudinal direction X. The first side plate 82 extends toward the −Z side from an end portion of the top plate 81 on the −Y side. The second side plate 83 extends toward the −Z side from an end portion of the top plate 81 on the +Y side. The second side plate 83 and the first side plate 82 face each other in the first direction Y. The first support plate 84 protrudes toward the +Y side from an end portion of the first side plate 82 on the −Z side. The second support plate 85 protrudes toward the −Y side from an end portion of the second side plate 83 on the −Z side.

The locking portion 86 protrudes from the top plate 81 to the +X side. A through-hole 86a is formed in the locking portion 86. In a state where the holding member 80 holds the relative position between the optical connector C and the receptacle 30, the protrusion 31a of the receptacle 30 is disposed inside the through-hole 86a (see FIG. 2).

As shown in FIG. 2, the holding member 80 has the biasing portion 82a that generates the biasing force in the first direction Y, two second biasing portions 81a that generate a biasing force in the second direction Z, and a third biasing portion 87 that generates a biasing force in the longitudinal direction X. The biasing portion 82a, the second biasing portion 81a, and the third biasing portion 87 of the present embodiment are elastic portions (plate springs) formed in a part of the holding member 80. However, some or all of the biasing portion 82a, the second biasing portion 81a, and the third biasing portion 87 may not be plate springs and may be configured of members separate from the holding member 80.

The biasing portion 82a is formed on the first side plate 82 and biases the pressure-receiving surface 53 of the ferrule 50 toward the +Y side. As shown in FIG. 5, in a case where the ferrule 50 is biased by the biasing portion 82a, the sliding surface 54 abuts against the receptacle-side sliding surface 34. Accordingly, the relative position between the ferrule 50 and the receptacle 30 in the first direction Y is determined. The receptacle-side sliding surface 34 and the sliding surface 54 are parts serving as references for the positions in the first direction Y.

The two second biasing portions 81a are formed on the top plate 81. The number of the second biasing portions 81a may be one. As shown in FIG. 6, the second biasing portions 81a press the upper wall 31 of the receptacle 30 toward the −Z side. In this case, the first support plate 84 and the second support plate 85 are in contact with the lower surface (the end surface on the −Z side) of the ferrule 50 and support the ferrule 50 from the −Z side. That is, the upper wall 31 of the receptacle 30 and the ferrule 50 are sandwiched between the first support plate 84 and the second support plate 85, and the second biasing portions 81a in the second direction Z. Accordingly, the relative position between the ferrule 50 and the receptacle 30 in the second direction Z is determined. The lower surface (end surface on the −Z side) of the upper wall 31 and the upper surface (end surface on the +Z side) of the ferrule 50 are parts serving as references for the positions in the second direction Z.

As shown in FIG. 2, the third biasing portion 87 protrudes toward the −Z side from the end portion of the top plate 81 on the −X side. The third biasing portion 87 biases the ferrule 50 toward the +X side. As shown in FIG. 5, in a case where the ferrule 50 is biased by the third biasing portion 87, the longitudinal reference surface 50a abuts against the positioning surface 35. Accordingly, the relative position between the ferrule 50 and the receptacle 30 in the longitudinal direction X is determined. The longitudinal reference surface 50a and the positioning surface 35 are reference planes for determining the position of the ferrule 50 with respect to the receptacle 30 in the longitudinal direction X. A reaction force toward the −X side due to the biasing force of the third biasing portion 87 acts on the holding member 80. The reaction force is supported by the protrusion 31a of the receptacle 30 via the locking portion 86.

As described above, in the present embodiment, positioning is performed by abutting the ferrule 50 and the receptacle 30 against each other in three directions (X, Y, and Z) without using a positioning pin. In this way, by not using the positioning pin, it is possible to reduce the external dimension (particularly, the dimension in the first direction Y) of the ferrule 50. Therefore, a larger number of optical connection units U can be disposed on the substrate 10, and the disposition density of the optical fibers F in a data center or the like can be increased.

Here, FIG. 5 shows a center line O passing through the center of the ferrule 50 in the longitudinal direction X. The longitudinal reference surface 50a is positioned between the center line O and the lens-forming surface 52 in the longitudinal direction X. With this disposition, the following effects can be obtained.

In a case where the longitudinal reference surface 50a is disposed on the distal end (end portion on the +X side) of the ferrule 50, the distance between the longitudinal reference surface 50a and the lens-forming surface 52 is excessively short. For this reason, in a case where the longitudinal reference surface 50a is butted against the positioning surface 35, dust or the like is likely to adhere to the lens L2. In a case where dust or the like adheres to the lens L2, this leads to an increase in connection loss of light between the optical fiber F and the optical integrated circuit 20.

Alternatively, in a case where the longitudinal reference surface 50a is disposed at the proximal end (the end portion on the −X side) of the ferrule 50, the distance between the longitudinal reference surface 50a and the lens L2 is excessively long. For this reason, in a case where the ferrule 50 is held in a state where the longitudinal reference surface 50a is inclined with respect to the positioning surface 35, the misregistration of the lens L2 with respect to the lens L1 is increased. Also in this case, this leads to an increase in connection loss of light between the optical integrated circuit 20 and the optical fiber F.

In contrast, as in the present embodiment, by disposing the longitudinal reference surface 50a between the center line O and the lens-forming surface 52, it is possible to suppress the misregistration of the lens L2 with respect to the lens L1 while suppressing the adhesion of dust to the lens L2. Therefore, in a case where the ferrule 50 is positioned without using pins, the optical connection quality can be stabilized.

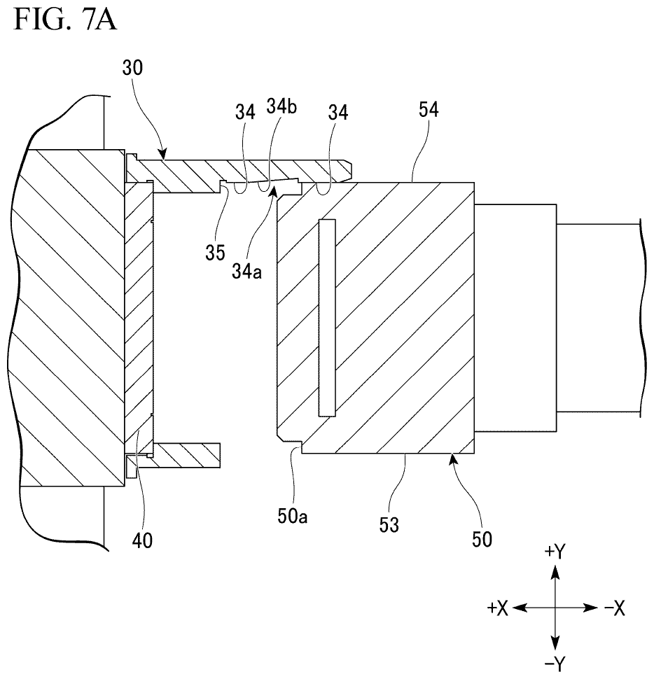

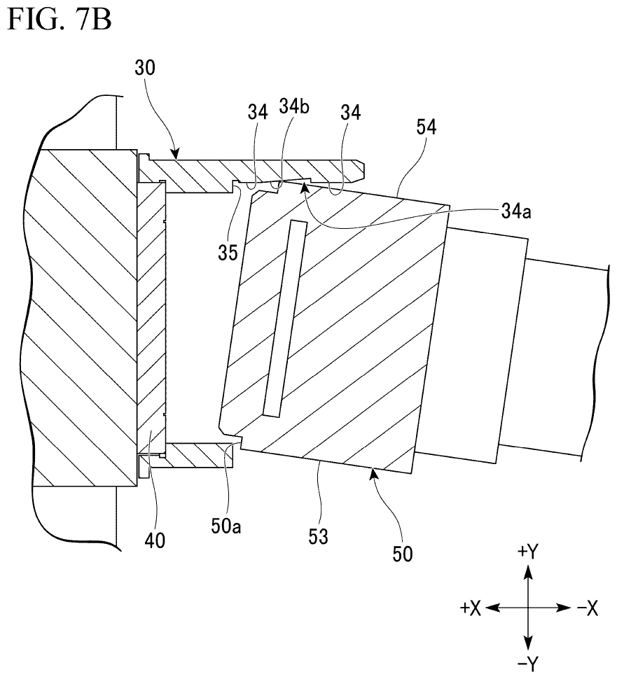

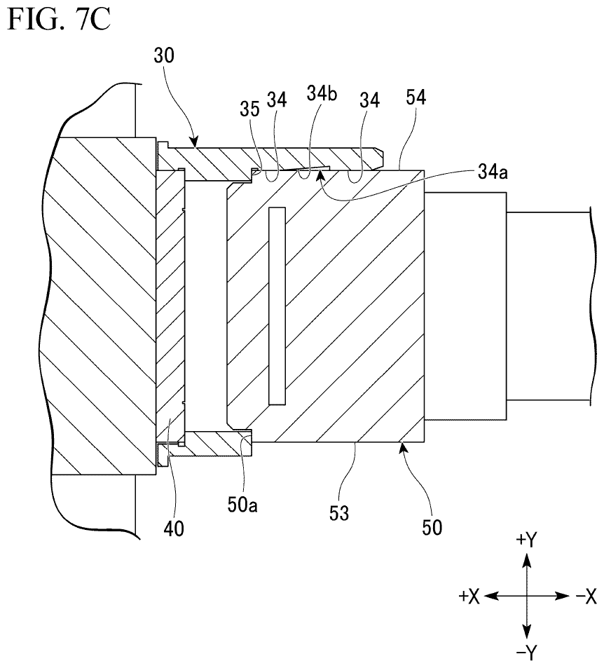

Next, the effect obtained by providing the recessed portion 34a and the inclined surface 34b will be described with reference to FIGS. 7A, 7B, and 7C.

In a case where the optical connector C is connected to the receptacle 30, as shown in FIG. 7A, the ferrule 50 is pushed to the +X side while the sliding surface 54 of the ferrule 50 is slid on the receptacle-side sliding surface 34. Here, it was found that in a case where the recessed portion 34a is not provided, the connection between the optical connector C and the receptacle 30 is easily completed in a state where the sliding surface 54 is inclined with respect to the receptacle-side sliding surface 34. In particular, since the biasing force by the biasing portion 82a acts on the ferrule 50, once the sliding surface 54 is inclined with respect to the receptacle-side sliding surface 34, there is a possibility that the biasing force may act to maintain the inclined state.

Thus, in the present embodiment, as shown in FIG. 7B, in a case where a corner portion of the ferrule 50 is made to enter the recessed portion 34a, the ferrule 50 is inclined with respect to the receptacle 30. In this state, in a case where the ferrule 50 is further pushed to the +X side, the ferrule 50 slides along the inclined surface 34b and the ferrule 50 moves to the +X side while the inclination is corrected. Eventually, in a case where the corner portion of the ferrule 50 passes through the recessed portion 34a to the +X side, as shown in FIG. 7C, the sliding surface 54 abuts against each of the receptacle-side sliding surfaces 34 divided into two portions by the recessed portion 34a. Here, as shown in FIG. 5, a position (hereinafter, referred to as a contact point) where the biasing portion 82a is in contact with the pressure-receiving surface 53 is in the vicinity of the center line O in the longitudinal direction X. For this reason, since the biasing force directed to the +Y side by the biasing portion 82a acts in the vicinity of the center of gravity of the ferrule 50, it is difficult for the inclination to occur in the ferrule 50. Moreover, the position of the contact point in the longitudinal direction X matches the position of the recessed portion 34a. Therefore, the biasing force by the biasing portion 82a acts to press the sliding surface 54 in a balanced manner against the receptacle-side sliding surfaces 34 divided into two locations. Accordingly, it is possible to effectively suppress the inclination of the ferrule 50 with respect to the receptacle 30.

As described above, in the present embodiment, the ferrule 50 to be connected to the receptacle 30 fixed to the optical integrated circuit 20 is provided. The ferrule 50 has the fiber hole 51 into which the optical fiber F is inserted, the light-emitting surface (in the present embodiment, the surface of the lens L2) from which the light that has passed through the optical fiber F is emitted, and the longitudinal reference surface 50a that determines the position of the ferrule 50 in the longitudinal direction X with respect to the receptacle 30. Then, the longitudinal reference surface 50a is positioned between the center line O passing through the center position of the ferrule 50 in the longitudinal direction X and the light-emitting surface. With such a configuration, it is possible to suppress an increase in connection loss of light due to a case where the distance between the light-emitting surface and the longitudinal reference surface 50a is too short or too long. Therefore, when performing positioning without using pins, it is possible to provide the ferrule 50 capable of stabilizing the optical connection quality.

In addition, the ferrule 50 has the lens L2 disposed at a position overlapping the fiber hole 51 as viewed from the longitudinal direction X. The light-emitting surface is the surface of the lens L2. According to this configuration, the light emitted from the optical fiber F can be adjusted by the lens L2 and then made to be incident into the microlens array 40. Therefore, the coupling efficiency of light can be improved.

In addition, in a case where the dimension between the longitudinal reference surface 50a and the light-emitting surface in the longitudinal direction X varies, the optical characteristics of the ferrule 50 are affected. Therefore, it is required that the manufacturing variation is small in the dimension between the longitudinal reference surface 50a and the light-emitting surface in the longitudinal direction X. Also, as the dimension between the longitudinal reference surface 50a and the light-emitting surface is smaller (that is, as the longitudinal reference surface 50a and the light-emitting surface are closer to each other in the longitudinal direction X), it is easier to suppress manufacturing variation. In consideration of this point, in the present embodiment, as shown in FIG. 6, the longitudinal reference surface 50a is positioned between the light-emitting surface (the surface of the lens L2) and the abutting surface 51a in the longitudinal direction X. The distance between the abutting surface 51a and the light-emitting surface is set to be small so that the optical signal emitted from the distal end of the optical fiber F is not dispersed in the ferrule 50. Therefore, by positioning the longitudinal reference surface 50a between the light-emitting surface and the abutting surface 51a, the dimension between the longitudinal reference surface 50a and the light-emitting surface is also reduced, and the above-described manufacturing variation can be reduced.

In addition, the ferrule 50 has the dustproof wall 56 that protrudes from the longitudinal reference surface 50a to surround the light-emitting surface. The adhesion of dust or the like can be more effectively to the light-emitting surface can be suppressed by the dustproof wall 56. In addition, for example, in a case where the distal end (end surface on the +X side) of the dustproof wall 56 is used as the longitudinal reference surface, the distal end of the dustproof wall 56 abuts against other structures. As a result, there is a possibility that shavings or the like generated by the abutment may enter the inside of the dustproof wall 56 and adhere to the light-emitting surface. In contrast, since the dustproof wall 56 protrudes from the longitudinal reference surface 50a, it is more difficult for the shavings or the like to adhere to the light-emitting surface.

In addition, the optical connection structure 1 of the present embodiment includes the ferrule 50, the receptacle 30, and the holding member 80 which holds a state in which the ferrule 50 and the receptacle 30 are positioned. The ferrule 50 has the pressure-receiving surface 53 that receives a biasing force in a direction (in the present embodiment, the first direction Y) intersecting with the longitudinal direction X of the fiber hole 51, and the sliding surface 54 that is disposed away from the pressure-receiving surface 53 and slides on the receptacle 30. The holding member 80 has the biasing portion 82a that applies a biasing force to the pressure-receiving surface 53, and the receptacle 30 has the receptacle-side sliding surface 34 that slides on the sliding surface 54. The recessed portion 34a into which a part of the ferrule 50 can enter is formed in the receptacle-side sliding surface 34. In a case where a direction in which light is emitted from the light-emitting surface (the surface of the lens L2) in the longitudinal direction X is set as the front side (the +X side), the inclined surface 34b that is inclined to be closer to the receptacle-side sliding surface 34 toward the front side is formed on the inner side of the recessed portion 34a.

According to such an optical connection structure 1, it is possible to more reliably suppress the inclination of the ferrule 50 with respect to the receptacle 30. In particular, in a case where the connection and the disconnection between the optical connector C and the receptacle 30 are repeated, the correction of the inclination is performed each time as shown in FIGS. 7A to 7C. Therefore, it is possible to suppress the variation in connection loss in a case where the repeated connection is performed.

In addition, the receptacle-side sliding surface 34 is divided into two portions in the longitudinal direction X by the recessed portions 34a. Accordingly, the sliding surface 54 of the ferrule 50 is pressed against the receptacle-side sliding surfaces 34 divided into the two portions. Therefore, the inclination of the ferrule 50 can be more reliably suppressed.

In addition, the technical scope of the present invention is not limited to the above-described embodiment, and various modifications can be made without departing from the spirit of the present invention.

For example, the light-emitting surface of the ferrule 50 may not be the surface of the lens L2. In the case of the ferrule 50 that does not have the lens L2, the surface 52 may be used as the light-emitting surface.

In addition, it is possible to appropriately replace the constituent elements in the above-described embodiment with well-known constituent elements without departing from the spirit of the present invention, and the above-described embodiment and modification examples may be appropriately combined.

### REFERENCE SIGNS LIST

1: Optical connection structure
20: Optical integrated circuit
30: Receptacle
34: Receptacle-side sliding surface
34a: Recessed portion
34b: Inclined surface
50: Ferrule
50a: Longitudinal reference surface
51: Fiber hole
51a: Abutting surface
53: Pressure-receiving surface
54: Sliding surface
56: Dustproof wall
80: Holding member
82a: Biasing portion
F: Optical fiber

1. A ferrule that is connected to a receptacle fixed to an optical integrated circuit,
the ferrule comprising:
a fiber hole into which an optical fiber is to be inserted;
a light-emitting surface from which light that has passed through the optical fiber is to be emitted; and
a longitudinal reference surface configured to determine a position of the ferrule with respect to the receptacle in a longitudinal direction of the optical fiber,
wherein the longitudinal reference surface is positioned between a center line passing through a center position of the ferrule in the longitudinal direction and the light-emitting surface.

2. The ferrule according to claim 1, further comprising:
a lens disposed at a position overlapping the fiber hole as viewed from the longitudinal direction, and
the light-emitting surface is a surface of the lens.

3. The ferrule according to claim 1 or 2, further comprising:
a abutting surface against which the optical fiber is butted inside the fiber hole, and
the longitudinal reference surface is positioned between the light-emitting surface and the abutting surface in the longitudinal direction.

4. The ferrule according to any one of claims 1 to 3, further comprising:
a dustproof wall configured to protrude from the longitudinal reference surface to surround the light-emitting surface.

5. An optical connection structure comprising:
the ferrule according to any one of claims 1 to 4;
the receptacle; and
a holding member configured to hold a state in which the ferrule and the receptacle are positioned,
wherein the ferrule includes a pressure-receiving surface configured to receive a biasing force in a direction intersecting with the longitudinal direction, and
a sliding surface that is disposed away from the pressure-receiving surface and slides on the receptacle,
the holding member has a biasing portion that applies the biasing force to the pressure-receiving surface,
the receptacle has a receptacle-side sliding surface that slides on the sliding surface,
a recessed portion into which a part of the ferrule is allowed to enter is formed in the receptacle-side sliding surface, and
in a case where a direction in which light is emitted from the light-emitting surface in the longitudinal direction is defined as a front side, an inclined surface that is inclined to be closer to the receptacle-side sliding surface toward the front side is formed on an inner side of the recessed portion.

6. The optical connection structure according to claim 5,
wherein the receptacle-side sliding surface is divided in the longitudinal direction by the recessed portion.
